(19) United States
(12) Patent Application Publication
(10) Pub. No.: US 2006/0242094 A1
(43) Pub. Date: Oct. 26, 2006

(54) Radiography system, and program executable in console

(75) Inventor: Yasuaki Tamakoshi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Medical & Graphic, Inc., Tokyo (JP)

(21) Appl. No.: 11/214,162

(22) Filed: Aug. 29, 2005

(30) Foreign Application Priority Data
Mar. 25, 2005 (JP) 2005-088864

(51) Int. Cl. G05B 13/02

(52) U.S. Cl. 706/23

(57) ABSTRACT

A radiography system has a console, wherein the console includes: a console communication unit to communicate via wireless communication with a cassette, the cassette including a cassette communication unit to communicate with the console via the wireless communication, a radiograph acquiring unit to acquire radiograph data by radiography, and a cassette control unit to control the cassette communication unit to transmit the radiograph data acquired from the radiograph acquiring unit; and a console control unit to control a display unit to display an indication informing that the wireless communication is in defective state when the console control unit has detected that the wireless communication is in defective state.

### BACKGROUND OF THE INVENTION

1. Field of the Invention

The present invention relates to a radiography system, and a program executable in a console.

2. Description of the Related Art

In the field of medical diagnosis, radiographs, as represented by X-ray images, have been used extensively. A radiation is an electomagnetic wave and/or a corpuscular beam, which have strong electrolytic dissociation activity and/or fluorescent activity, including heavily-charged corpuscular beams and neutron beam, such as X-rays, γ-rays, β-rays, α-rays, deuteron beam and proton beam. The radiograph is an image acquired by irradiating radiation onto a subject to detect the intensity distribution of the radiation having passed through the subject.

For acquiring radiographs, CR (Computed Radiography) and a radiography apparatus using a film are known. The radiography system using CR, however, requires a long time, such as several tens of seconds to several minutes, in order to check an acquired image after irradiation of radiation. Due to that, when any defect is detected in the radiograph, it might be required to ask a person to come back to a radiography room and to re-perform radiography.

In order to solve the above-mentioned inconvenience, a radiography system using FPD (Flat Panel Detector) adapted to detect radiation having passed through an subject to convert them into electric signals and store them as radiograph information has been proposed. With this radiography system using FPD, it is possible to check an acquired image after irradiation of radiation within a short period of time, such as several seconds.

Further, a technology of cassette containing FPD and provided therein with a wireless communication unit and an internal electric power source has been disclosed in JP-Tokukai-2004-180931A (corresponding to US 2004-114725A). This cassette having no wiring is enabled to communicate with a console via a wireless communication and supply power from the internal electric power source inside the cassette. In addition, this cassette has advantages of high handling ability and free carrying.

Moreover, another technique of providing a cassette including a wireless communication unit and an internal electric power source with a connector capable of connecting with either of a radio module or a cable has been disclosed in JP-Tokukai-2004-173907A. This cassette is configured such that an operator can select one of two modes, with one of which radiography is performed with high handleability under a condition where the operator connects the cassette with a radio module, and with the other of which a number of radiography is performed in series by connecting the cassette with a cable without paying attention to the capacity of an internal electric power source.

However, as a result of my diligent study, it was found out that the cassette using wireless communication has such a problem that the wireless communication between the cassette and a console is inclined to be disabled or defective depending on the arrangement of the subject and the cassette in comparison with the cable communication.

There are various types of wireless communications. But, as a section for performing high-speed communication with mass capacity data such as X-ray image data, optical communications (i.e., with tera-waves, infrared waves, visible light or ultraviolet rays), communications using high frequency radio wave such as microwave, and the like are exemplified.

However, in a case of the optical communication, if there is an obstacle on the communication path, the communication will be disabled. On the other hand, in a case of a radio wave with high frequency, such as microwave, since it has strong rectilinear propagation property and strong directivity, there is a problem for the radio wave communication, for example, of “Shadowing” meaning that, if any obstacle is on the communication path, the signals are interrupted by the obstacle and cannot reach to behind the obstacle, or of “Multi Pass Fading” meaning that the signals be weakened due to synthesis of various reflections of the radio waves.

Since, in particular, X-ray radiography with use of a radiograph acquiring device is performed with finely adjusting the arrangements of the radiograph acquiring device and a subject, it was found out that troubles in the communication might be easily caused in such a way that the subject acts as an obstacle due to the positioning in the arrangements of the radiograph acquiring device and the subject, or that the other article such as a generating stage acts as an obstacle or a reflective structure due to the positioning in the arrangements of the radiograph acquiring device and the other article such as a generating stage, or from the directivity of the communication unit of the radiograph acquiring device.

Also, because the X-ray radiography is performed with adjusting the positioning in the arrangements of the cassette and a subject, it was found out that the subject might act as an obstacle to cause a trouble in the communication depending upon the arrangement. In particular, radio wave absorption and/or reflection may be caused when an X-rays shielding material made from metal for preventing acquired images from being affected by X-rays scattering is provided in the cassette, or when an electrically conductive member made from, for example, aluminum is provided as a housing inside the cassette. Besides, in a case that the cassette is provided with an antenna for wireless communication use, when the metallic X-ray shielding material or the electrically conductive housing is disposed so as to be close to the antenna for wireless communication to prevent the antenna from hitting the subject or from being broken by the subject, strong directivity will be caused in the wireless communication in the cassette side, thereby the subject may act as an obstacle, raising the probability of the occurrence of communication defect and/or communication disablement.

Incidentally, for example, in the technique described in JP-Tokukai-2004-173906 (corresponding to US 2004-114725A) in which a cassette provided with a wireless communication unit and an internal electric power source has a connector which can be connected with any of a wireless module and a cable, a cassette-type X-ray image detector has a connector connectable to a radio module or a cable to communicate with a system controller. When an operator could set and remove the radio module or the cable to the connector optionally, it is inferred that the whole efficiency of radiograph could be rather lowered due to faults of setting the radio module by the operator, the frequency of which could be far greater than that of the occurrence of the communication disablement. More specifically, since it is not possible to determine at the console side whether the wireless communication is disabled under the state where the radio module being connected to the connector of the cassette or where the radio module being not connected to the cassette, an operator is required to account to the both probability and take the countermeasures when the communication disablement with the cassette at the console side is recognized.

### SUMMARY OF THE INVENTION

Therefore, the present invention is aiming at solving the above-described problems, and it is an object of the present invention to provide a radiography system capable of efficiently generating, in which acquired radiographs cannot be acquired by intercepting the generating of radiographs when the communication between the cassette and the console is disabled, and unnecessary irradiation of radiation to the subject is prevented from being applied.

### BRIEF DESCRIPTION OF THE DRAWINGS

FIG. 1 shows a schematic structure of an X-ray radiography system of a first embodiment;

FIG. 2 is a view showing one example of a screen display on a display unit in a good communication state of the X-ray radiography system according to the present invention;

FIG. 3 is a view showing one example of a screen display on the display unit in a defective communication state of the X-ray radiography system according to the present invention;

FIG. 4 is a view showing one example of a screen display on the display unit in a communication disabled state of the X-ray radiography system according to the present invention;

FIG. 5 is a view showing one example of a screen display on the display unit in a good communication state of the X-ray radiography system according to the present invention;

FIG. 6 is a view showing one example of a screen display on the display unit in a defective communication state of the X-ray radiography system according to the present invention;

FIG. 7 is a view showing one example of a screen display on the display unit in a communication disabled state of the X-ray radiography system according to the present invention;

FIG. 8 is a view showing one example of a screen display on the display unit in a good communication state of the X-ray radiography system according to the present invention;

FIG. 9 is a view showing one example of a screen display on the display unit in a defective communication state of the X-ray radiography system according to the present invention;

FIG. 10 is a view showing one example of a screen display on the display unit in a communication disabled state of the X-ray radiography system according to the present invention;

FIG. 11 is a perspective view showing a schematic structure of a cassette according to the present invention;

FIG. 12 is a sectional view of the cassette around a panel according to the present invention;

FIG. 13 is a circuit diagram showing a structure of a circuit around a light detector according to the present invention;

FIG. 14 is a flowchart of operations taken place when detecting the communication state between a cassette communication unit and a wireless communication repeater according to the present invention; and

FIG. 15 is a view showing a schematic structure of an X-ray radiography system of the second embodiment.

### DETAILED DESCRIPTION OF THE PREFERRED EMBODIMENTS

The embodiment of a radiography system, a console, and a program executable in the console will be explained with reference to the drawings.

The following explanation describes some embodiments that are envisaged by the inventors as the best modes in order to carry out the present invention. Although there are expressions in the description which seem to predicate or define the claims and the terms used in the claims, it should be understood that these expressions are made to define the embodiments having been envisaged as the best modes and are not intended to define the scopes of the claims and the terms used in the claims.

Note that, in the following description, the term of “console” denotes an apparatus to be used by an operator in order to communicate with a cassette. A display unit being structured separately may be connectable to the console, or it may be structured integrally with the console. Furthermore, an operation input unit being structured separately may be connectable to the console, or it may be structured integrally with the console.

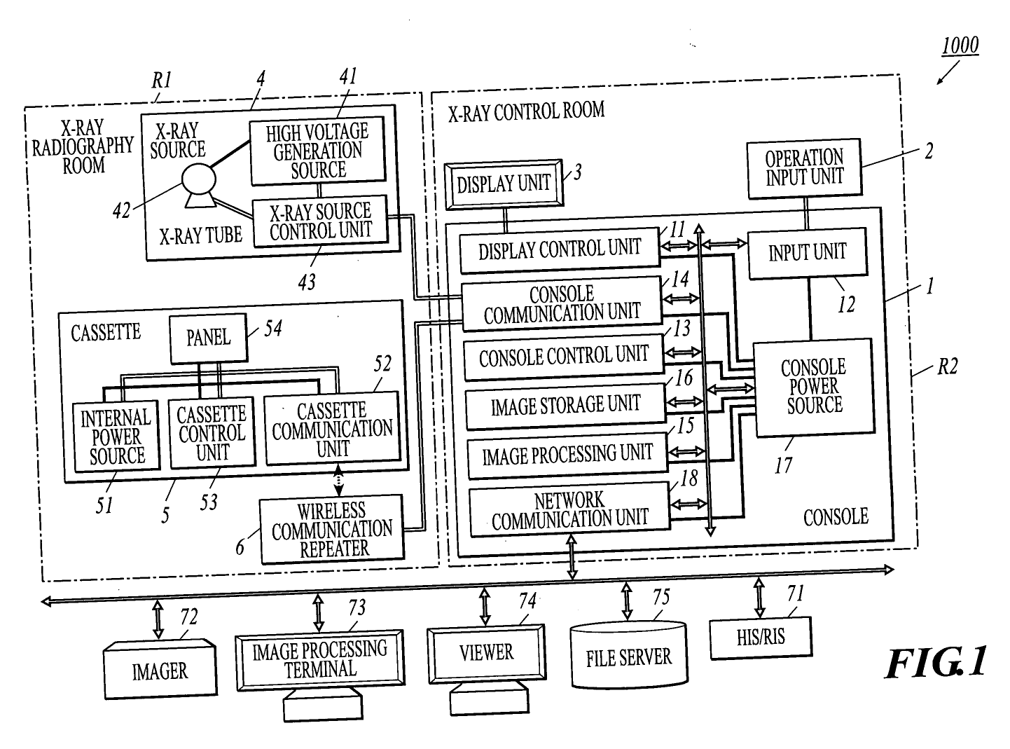

Now, the first embodiment of an X-ray radiography system according to the present invention will be explained with reference to FIGS. 1 to 14.

As shown in FIG. 1, the X-ray radiography system 1000 according to the first embodiment is a system assumed to be used for X-ray radiography carried out in hospitals. For example, the X-ray radiography system 1000 is placed in an X-ray radiography room R1 for irradiating X-rays to a subject and an X-ray control room R2 where an X-ray operator performs a control of X-ray irradiation to a subject and image processes of X-ray images acquired by irradiating X-rays to the subject.

In the X-ray control room R2, a console 1 is provided. With the console 1, the entire X-ray radiography system is controlled, whereby the control of X-ray radiography and image processing of the acquired X-ray images are carried out.

To the console 1, an operation input unit 2 with which an operator inputs a radiography preparation instruction, a radiography instruction, or contents of the instruction is connected. As the operation input unit 2, for example, an X-ray irradiation request switch, a touch panel, a mouse, a keyboard, a joystick, etc. may be used. Through the operation input unit 2, instructions including X-ray radiation conditions, such as X-ray tube voltage, X-ray tube current and X-ray irradiation time, X-ray radiography control conditions such as radiography timing, radiograph region and radiography manner, image processing condition, image output condition, cassette-selecting information, order selecting information, subject ID, etc. are input.

Further, to the console 1, a display unit 3 to display X-ray images and the like is further connected, and a display is controlled by a display control unit 11 constituting the console 1. As the display unit 3, for example, a monitor, such as a liquid crystal monitor and a CRT (Cathode Ray Tube) monitor, an electronic paper, an electronic film and the like may be used. The display unit 3 displays literations indicating X-ray radiography conditions, image processing conditions and the like and X-ray images.

The console 1 includes the display control unit 11, an input unit 12, a console control unit 13, a console communication unit 14, an image processing unit 15, an image storage unit 16, a console power source 17, a network communication unit 18, etc. The display control unit 11, the input unit 12, the console control unit 13, the console communication unit 14, the image processing unit 15, the image storage unit 16, the console power source 17, and the network communication unit 18 are connected to buses, respectively, and are data-exchangeable, respectively.

The input unit 12 receives the operation inputs corresponding to the instruction contents by an operator from the operation input unit 2.

The console control unit 13 determines a radiography condition on the basis of the instruction contents corresponding to the operation inputs received by the input unit 12 from the operation input unit 2 and order information received by the network communication unit 18 from HIS/RIS71, and controls the console communication unit 14 such that the console communication unit 14 transmits radiography condition information regarding radiography conditions as signals for radiography to the X-ray source 4 and the cassette 5 and properly transmits the signals for radiography to be required for radiography, thereby controlling the X-ray source 4 and the cassette 5 to perform X-ray radiography.

The console control unit 13 further controls to temporarily store in the image storage unit 16 X-ray image data received by the console communication unit 14 from the cassette 5. Furthermore, the console control unit 13 controls to prepare thumbnail image data from the X-ray image data temporarily stored by the image processing unit 15 in the image storage unit 16. The display control unit 11 controls the display unit 3 so that it displays thumbnail images on the basis of the prepared thumbnail image data. The console control unit 13 controls such that the image processing unit 15 applies image processing on the basis of the instruction contents corresponding to the operation inputs received by the input unit 12 and the order information of HIS/RIS71 to the X-ray image data, and the image storage unit 16 stores the image-processed X-ray image data. Following thereto, the console control unit 15 controls the display control unit 11 so that the display unit 3 displays the thumbnail images of the processed result on the basis of the X-ray image data as the result of the image processing by the image processing unit 15. Moreover, the console control unit 13 controls the display control unit 11 so that the display unit 3 displays image reprocessing of the X-ray image data and the results thereof on the basis of the instruction contents corresponding to the operation inputs received later by the input unit 12 from the operation input unit 2 and controls the network communication unit 18 so that the X-ray image data is transmitted to, stored in or displayed by an external device on the network.

As the console control unit 13, it is possible to apply a mother board equipped with one or more CPU (Central Processing Unit) and one or more memory, such as RAM (Random Access memory) or ROM (Read Only Memory).

A CPU reads out a program stored in the ROM or a hard disk, develops the program in the RAM, and controls the respective components of the console 1, the X-ray source 4, the cassette 5 and the external device in accordance with the developed program. In addition thereto, the CPU reads out the respective processing programs including a system program and the others stored in the hard disk to develop them in the RAM, and then executes various processing to be described later.

The RAM forms work areas for temporarily storing various programs which are read out from the ROM and may be executed by the CPU, respectively in various processing executed and controlled by the CPU in the console control unit 13, input/output data and the like. And the RAM is, for example, a volatile memory.

The ROM is a nonvolatile memory and stores the system program to be executed by the CPU and the various programs corresponding to the system program and the like. The various programs are housed in the form of readable program code, and the CPU successively executes performances in accordance with the program code.

Besides, the ROM can be replaced by a hard disk. In this case, the hard disk stores the system program to be executed by the CPU and various application programs. The hard disk can also be configured such that the part or the whole thereof receives and stores various application programs including the programs for executing the present invention from the console communication unit 14, which has received those application programs from the other hardware such as a server via the transmission medium of a network line. Furthermore, the CPU may be configured such that it receives various application programs including the programs for executing the present invention from a storing device, such as a hard disk, of a server established on a network, develops those programs on the RAM, and executes various processing, for example, the processing according to the present invention.

The display control unit 11 controls the display unit 3 under the control of the console control unit 13 so that it displays images and characters based on image data, character image data and the like. As the display control unit 11, a graphic board and the like may be used.

The console communication unit 14 is connected to the X-ray source 4 and the wireless communication repeater 6, respectively, through a communication cable, and the console communication unit 14 can communicate with the cassette 5 via the wireless communication repeater 6. The console communication unit 14 can transmit various control signals according to the instruction contents given from the console control unit 13 and signals for radiography in regard to various information to the X-ray source 4 and the cassette 5, and can receive X-ray image data, various control signals, and signals for radiography in regard to various information from the cassette 5.

When the console communication unit 14 receives an instruction to transmit a signal for radiography for acquiring X-ray image data by means of X-ray radiography from the console control unit 13, the console communication units 14 controls the wireless communication repeater 6 to wirelessly output the signal for radiography. The signal for radiography thus transmitted from the console communication unit 14 includes, for example, radiography condition information in regard to radiography conditions, radiography preparation-instruction signal for shifting from the sleep mode or radiography standby state described later to the photographable state, and radiography instruction signal for instructing X-ray radiography. Besides, the signal for radiography received by the console communication unit 14 from the cassette 5 includes, for example, radiography capable state shifting signal indicating that the cassette 5 has been shifted in the radiography capable state, preparation completion signal indicating that the cassette 5 has been exposed to X-ray irradiation and is ready to acquire X-ray image data, and X-ray irradiation completion signal indicating that the quantity of X-ray irradiation having been reached to a predefined level.

Further, the console communication unit 14 can transmit signals for radiography, such as various control signals and various other information, those which are based on the instruction contents, to the X-ray source 4, and it can also receive signals for radiography, such as signals for informing the operational states and various other information, from the X-ray source 4.

The wireless communication repeater 6 can detect the communication state of wireless communication through the reduction in the received radio wave intensity in the wireless communication and the noise quantity in the wireless communication range. In this case, the wireless communication repeater 6 transmits the information on the communication state of the wireless communication between the cassette communication unit 52 and the wireless communication repeater 6 detected by the wireless communication repeater 6 to the console communication unit 14. When the console communication unit 14 received the information, the console control unit 13 detects the communication state of the wireless communication.

Alternatively, the detection of the wireless communication state may be performed by detecting the executing communication speed. In this case, the executing communication speed may be detected by means of the wireless communication repeater 6 or the console communication unit 14. Then, the console control unit 13 detects the communication state of the wireless communication based on the information of the executing communication speed.

On the other hand, while the console communication unit 14 detects that it is receiving the X-ray image data from the cassette 5, that is, in a case where the console communication unit 14 is receiving the X-ray image data from the cassette 5, the console control unit 13 controls the display control unit 11 so that the display unit 3 displays that the communication unit 14 is receiving the X-ray image data. Besides, when the console control unit 13 has detected a state where the wireless communication is disabled while the display unit 3 is displaying that the communication unit 14 is receiving the X-ray image data, the console control unit 13 controls the display control unit 11 so that the display unit 3 interrupts the display indicating that the X-ray image data is under being received.

When the console control unit 13 has detected that the wireless communication between the cassette communication unit 52 and the wireless communication repeater 6 is defective, that is, when the console control unit 13 has detected that the wireless communication is in defective state, the console control unit 13 controls the display control unit 11 so that it displays such an indication that the wireless communication is in defective state. The display indicating that the communication being defective may be a display stating that the communication is defective, or a display of the absolute values, the relative values, the levels and the like of the communication speed or the intensities of the wireless communication wave (e.g., radio field intensity or light-receiving intensity), or a display of the absolute values, the relative values, the levels and the like of S/N, or displays in the other forms.

For example, similarly to the display of a portable telephone for indicating the receiving condition, the display of the communication state may be configured to be showed in the notification field of the task bar in the Windows (registered trademark) in such manners that the communication being in good condition is indicated with an antenna mark and three standing indicators, the communication being in defective state is indicated with an antenna mark and one or two standing indicators depending upon the levels of the defective degree, and the communication being disabled is indicated with an antenna mark and no standing indicators. However, indications being easy to understand in any other manners may be employed.

As the modification, the X-ray radiography system according to the present invention may be configured such that the console communication unit 14 produces analog signals for wireless communication from the digital signals and converts the wirelessly received analog signals to the digital signals, and the wireless communication repeater 6 works as an antenna of the console communication unit 14 to perform radio transmission with use of the analog signals for wireless communication from the console communication unit 14 and transmits the radio-received analog signals to the console communication unit 14. In this configuration, the console communication unit 14 can detect the communication state of the wireless communication from the reduction in the received wave intensity, the quantity of noises in the wireless communication band, etc. In this case, information on the communication state of the wireless communication between the cassette communication unit 52 and the wireless communication repeater 6 detected by the console communication unit 14 is transmitted to the console control unit 13, and the console control unit 13 then detects the communication state of the wireless communication.

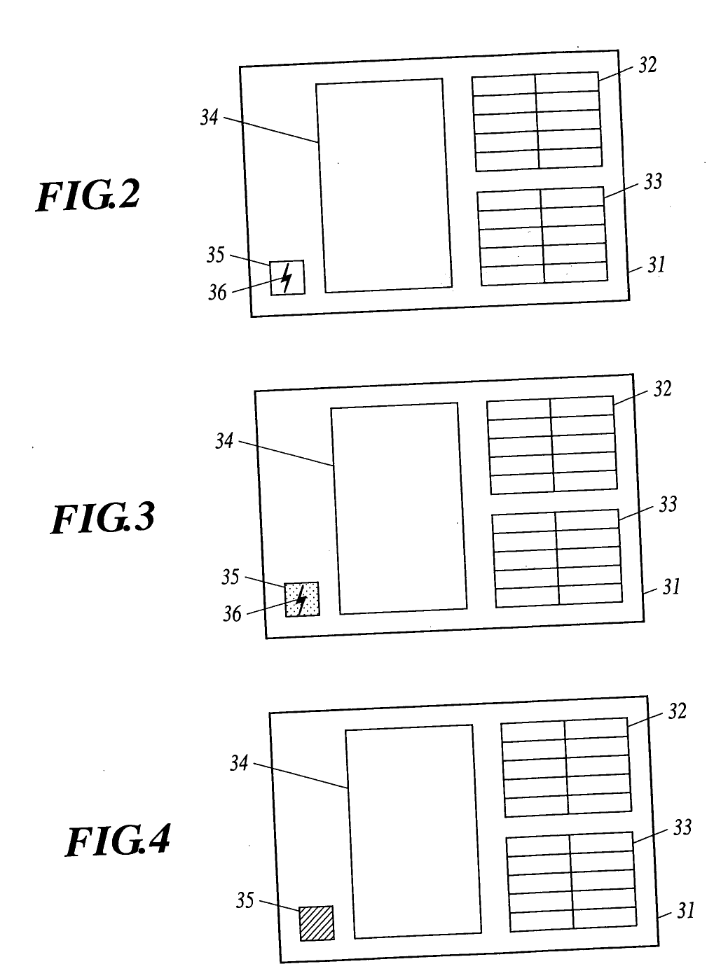

Examples of displays on the display screen 31 of the display unit 3 are shown in FIGS. 2 to 4. In these examples, an order information display unit 32 to display order information, a radiography condition display unit 33 to display information on radiography conditions, an X-ray image display section 34 to display thumbnail images of X-ray images, and a communication state display section 35 to display the communication states of wireless communications between the cassette communication unit 52 and the wireless communication repeater 6 are provided on the display screen 31.

When the communication state between the cassette communication unit 52 and the wireless communication repeater 6 is in a good condition, the background of the communication state display section 35 is displayed with green color as shown in FIG. 2. Whereas, when the communication state of the same is in a defective state, the background of the communication state display section 35 is displayed with yellow color as shown in FIG. 3. Further, when the communication state of the same is in a communication-disabled condition, the background of the communication state display section 35 is displayed with red color as shown in FIG. 4. Based on the colors of the background of the communication state display section 35 being variable depending on the communication state, the operator can comprehend how the communication state between the cassette communication unit 52 and the wireless communication repeater 6 is. Besides, during reception of X-ray image data, an image-under-reception display section 36 for indicating that X-ray image is under reception is displayed on the display screen, whereas the image-under-reception display section is not displayed when no X-ray image is received. In this case, a mark locating in the middle of the communication state display section 35 corresponds to the image-under-reception display section 36.

Besides, a communication state display section 35, that is another example of the communication state display section on the display screen 31 of the display unit 3, is shown in FIGS. 5 to 7.

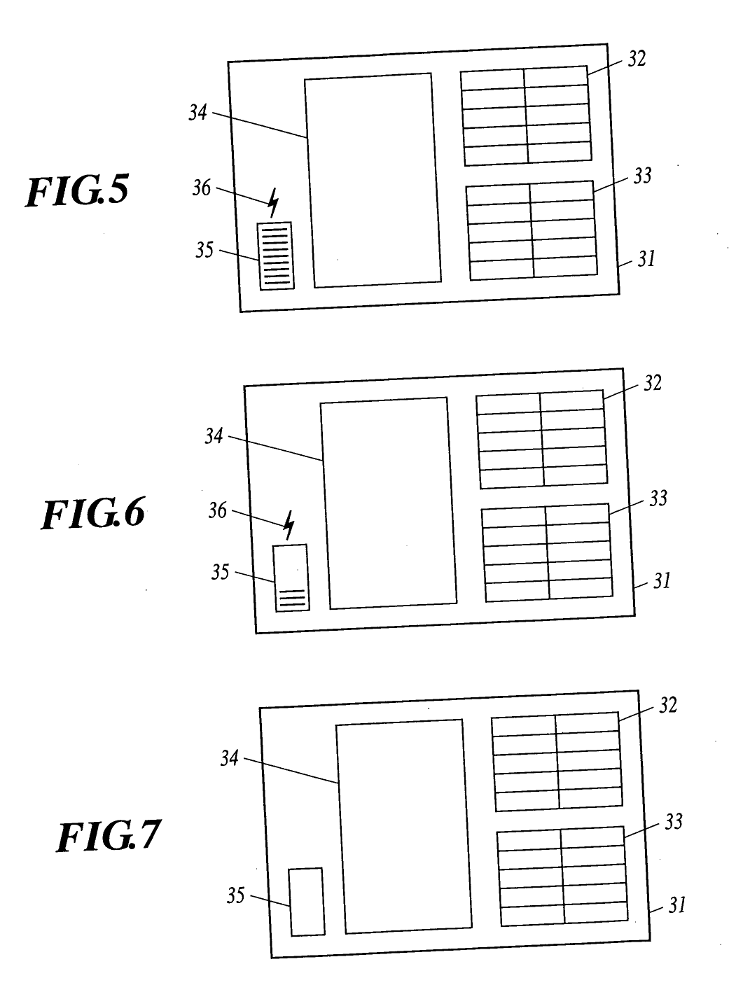

As shown in FIG. 5, when the communication state between the cassette communication unit 52 and the wireless communication repeater 6 is in a good communication condition, horizontal bars for indicating a communication state between the cassette communication unit 52 and the wireless communication repeater 6 is displayed over the display range of the communication state display section 35. Whereas, when a communication state between the cassette communication unit 52 and the wireless communication repeater 6 is in a defective state, the horizontal bars, the number of which being corresponding to the level of the communication state, are displayed in the display range of the communication state display section 35, as shown in FIG. 6. Besides, when a communication state between the cassette communication unit 52 and the wireless communication repeater 6 is in a communication-disabled condition, the horizontal bars indicating the communication state are not displayed in the display range of the communication state display section 35, as shown in FIG. 7. Therefore, the operator can note the communication state between the cassette communication unit 52 and the wireless communication repeater 6 based on the indicated horizontal bars, the number of which being corresponding to the level of the communication condition, displayed in the display range of the communication state display section 35.

Further, during a reception of X-ray image data, the image-under-reception display section 36 indicating that X-ray image data is under reception is displayed, whereas the image-under-reception display section is not displayed when no X-ray image data is received. In this case, a mark locating above the communication state display section 35 corresponds to the image-under-reception display section 36.

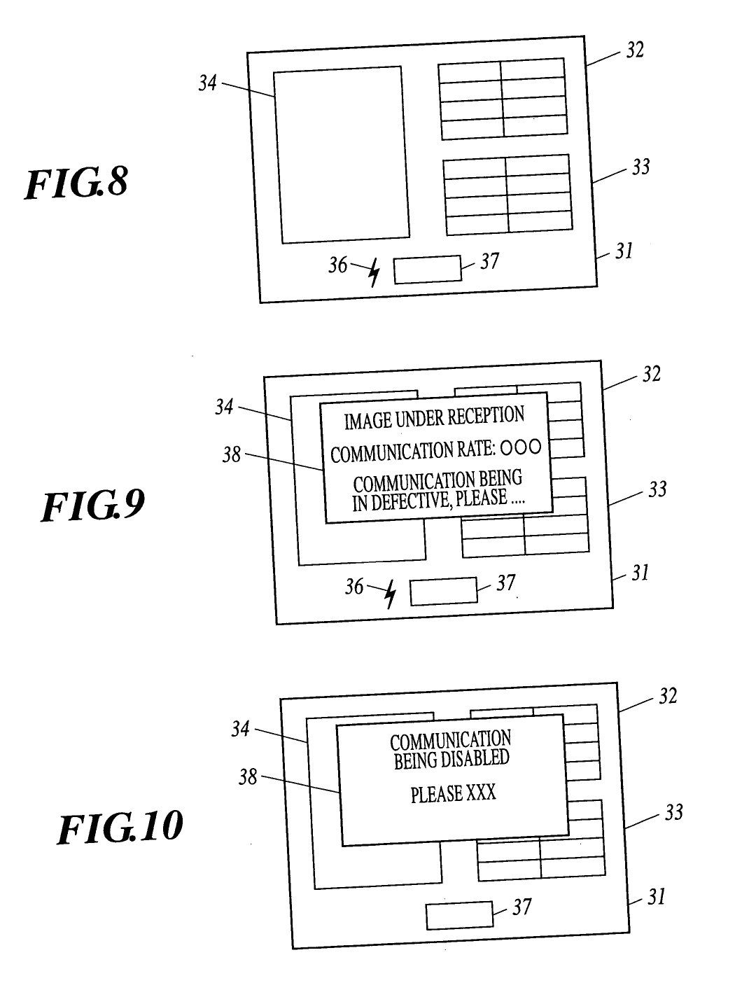

A further example is shown in FIG. 8 wherein a communication state display button 37 is provided underneath the display unit 3 to display order selection information and radiography conditions for the operation input unit 2. In response to focusing the communication state display button 37 made by an operational input from the operation input unit 2 and subsequent pushing down or clicking an enter key in the operation input unit 2, the display control unit 11 controls the display unit 3 so that it opens a communication state display screen 38 indicating a communication state between the cassette communication unit 52 and the wireless communication repeater 6 at the most front surface in the display screen 31 of the display unit 3. FIG. 9 shows an example of a communication state display screen 38 when the communication state between the cassette communication unit 52 and the wireless communication repeater 6 is in a defective state. In this example, indications of an image being under reception from the cassette communication unit 52, a communication rate going on between the cassette communication unit 52 and the wireless communication repeater 6 and the communication being in a defective state are displayed on the communication state display screen 38. FIG. 10 shows an example of the communication state display screen 38 when a communication state between the cassette communication unit 52 and the wireless communication repeater 6 is in a communication-disabled condition. In this case, an indication notifying that the wireless communication between the cassette communication unit 52 and the wireless communication repeater is in a communication-disabled condition is displayed. When the communication state is in the defective or disabled condition as described above, it is preferable to display an indication on the communication state display screen 38 for directing an operation to be conducted by the operator in order to recover the communication state.

Besides, during a reception of X-ray image data, an indication notifying that X-ray image data having been received is displayed on the image-under-reception display section 36, whereas no indication thereof is displayed when X-ray image data is not received. In this case, a mark locating laterally to the communication state display button 37 corresponds to the image-under-reception display section 36. Alternatively, the image-under-reception display section 36 may be displayed in the communication state display screen 38.

It is needless to display the communication state display screen 38 all the time, and it may be displayed only at necessary occasions. Also, the communication state display section 38 is not required to be displayed on the most front screen, and it may be displayed behind the other screen and then displayed on the most front screen upon necessity. However, at least when the communication state is in a defective state, it is preferable to display an indication informing the communication state on the most front screen at least until a predetermined operation is carried out. Furthermore, when the communication state is in a defective or disabled condition, it is particularly preferable to display an indication informing the communication state on the most front screen at least until a predetermined operation is carried out.

As described above, it is needless to display the communication state display screen 38 all the time, and it may be displayed upon necessity. Besides, the communication state display screen 38 is not required to be displayed on the most front screen all the time, and it may be displayed behind the other screen and then displayed on the most front screen upon necessity. However, at least when the communication state is in a defective state, it is preferable to display an indication informing the communication state on the most front screen at least until a predetermined operation is carried out. Furthermore, when the communication state is in a defective or disabled condition, it is particularly preferable to display an indication informing the communication state on the most front screen at least until a predetermined operation is carried out.

Besides, the wireless communication repeater 6 may be formed into a cradle for the cassette 5 so that the cassette 5 may be detachable and be substantially communication-connected via a wired communication line to the foresaid communication cable having been connected to the console communication unit 14. In this case, it is preferable that the communication state display section 35, 32 or the communication state display screen 38 displays an indication different from the previous one notifying being on a wired communication line.

The image processing unit 15 performs image processing of the X-ray image data that the console communication unit received from the cassette 5. The image processing unit 15 performs image processing, such as correction, enlarging, reduction, compressing, spatial filtering, recursive, gradation, scattered rays correction, grid correction, frequency emphasis, dynamic range compression and the like, of the image data in accordance with the instruction contents.

The image storage unit 16 temporarily stores X-ray image data that the console communication unit 14 received from the cassette 5 and stores the image-processed X-ray image data. As the image storage unit 16, a hard disk as a rapid memory having a large capacity, a hard disk array such as RAID (Redundant Array of Independent Disks), a silicon disk, and the like may be used.

The console power source 17 is supplied with electric power from an external power source (not shown) such as AC power source, or an internal power source, such as batteries and cells, and the console power source 17 supplies electric power to the respective components comprising the console 1.

The external power source for the console power source 17 is configured to be attachable and detachable. If the console power source 17 is supplied with electric power from the external power source, it can perform the radiography for a long time since no charging is required.

The network communication unit 18 is configured to perform communications of various information between the console 1 and an external device through LAN (Local Area Network). As the external device, for example, an HIS/RIS (Hospital Information System/Radiology Information System) terminal 71, an imager 72, an image processing device 73, a viewer 74, a file server and the like may be connected. The network communication unit 18 outputs X-ray image data to the external device in accordance with a fixed protocol such as DICOM (Digital Imaging and Communication in Medicine).

The HIS/RIS terminal 71 acquires information on the subject, radiography region, radiography manner, etc. from the HIS/RIS, and provides the information to the console 1. The imager 72 records X-ray images on a recording medium such as a film based on the X-ray image data output from the console 1. The image processing device 73 performs image processing of the X-ray image data output from the console 1 and processing for CAD (Computer Aided Diagnosis) to store them in the file server 75. The viewer 74 displays X-ray images based on the X-ray image data output from the console 1. The file server 75 is a file server adapted to store the image-processed X-ray image data. The network communication unit 18 outputs the X-ray image data to the external device in accordance with a predetermined protocol such as DICOM (Digital Imaging and Communications in Medicine).

It is exemplified in this embodiment that the display control unit 11 and the console control unit 13 are separately provided, however, the display control unit and the console control unit may be provided integrally. As the example for such a configuration, a mother board mounted with a CPU and a memory may be used as the console control unit, and a graphic subsystem contained in the mother board may be used as the display control unit. The console control unit 15 may concurrently play as the display control unit. Further, in this embodiment, though the image processing unit 15 and the console control unit 13 are separately provided, the console control unit 13 may concurrently play as the image processing unit.

In the X-ray radiography room R1, the X-ray source 4 for irradiating X-rays to a subject and the cassette 5 for detecting the X-rays irradiated to the subject to acquire the X-ray image data are placed. The X-ray radiography room R1 is constructed to be room surrounded with X-ray shielding material so that X-rays from the X-ray source 4 do not leak out of the X-ray radiography room R1. Typically, such the X-ray shielding material covering the room is a metallic member, for example a lead plate, namely an electrically conductive member, having characteristics of preventing the penetration of waves and reflecting waves.

In this embodiment, the cassette 5 is configured in a portable type, permitting it to be brought out of the X-ray radiography room R1.

Further, the wireless communication repeater 6 is located in the X-ray radiography room R1. The wireless communication repeater 6 performs wireless communication with the cassette 5. Further, the wireless communication repeater 6 performs wireless communication with the console 1 via a communication cable. Therefore, no communication cable is required for the communication between the cassette 5 and the wireless communication repeater 6. Thus, it is avoidable to pay careful attention when handling the cassette 5 so that the cable is not coiled around the subject during X-ray radiography.

The wireless communication repeater 6 performs communication with the console 1 via a communication cable. The X-ray image data acquired by the cassette 5 is transmitted to the console 1 via the wireless communication repeater 6, and control signals and signals for radiography such as various information are communicated between the console 1 and the cassette 5. By connecting the console 1 and the wireless communication repeater 6 with a cable, and placing the wireless communication repeater 6 in the X-ray radiography room R1, the wireless communication with the console 1 in a good condition is ensured even though the cassette 5 is used in the X-ray radiography room R1 that is isolated from the console 1 with the surrounding radiation shielding material.

As described above, it is structured in this embodiment such that the cassette 5 and the wireless communication repeater are placed in the X-ray radiography room R1 and the console 1 is placed in the X-ray control room R2. With such a structuring, the communication between the cassette 5 and the wireless communication repeater 6 is attainable without causing substantial attenuation due to penetration through an X-ray-shielding material (generally a lead plate being an electrically conductive member) surrounding the X-ray radiography room R1, and on the other hand, the communication between the wireless communication repeater and the console 1 can be made in a good condition both outside and inside the X-ray radiography room R1 via the communication cable.

As the method for performing the wireless communication, a method to use radio waves to establish the communication, and methods to use infrared rays, visible light, ultraviolet rays and the like to establish the communication are employed. The method to use radio waves to establish the communication includes a method to use radio waves having a frequency exceeding 1 GHz to establish the communication and a method to use radio waves having a frequency less than 1 GHz to establish the communication.

The method to use radio waves having a frequency exceeding 1 GHz to establish the communication includes, for example, a method using a next generation portable telephone employing, for example, 1.4 GHz band, 2 GHz band and 2.1 GHz band, a method using a radio LAN by employing 2.4 GHz band and 5.2 GHz band, those which meet the standard such as IEEE 802.11a, 802.11b, 802.11g, etc., a method using FWA (Fixed Wireless Access) employing 18 GHz band and 19 GHz band, methods based on the wireless communication standards including a method using Bluetooth employing 2.45 GHz band and a method using Home RF (Home Radio Frequency) employing 2.4 GHz band, a communication method using UWB (Ultra Wide Band), namely radio waves of an ultra wide band, and a method using the industrial, scientific and medical band (ISM) employing 2.4 GHz bans and 5.8 GHz.

The method using radio waves having a frequency less than 1 GHz to establish the communication includes, for example, a method using a specified low power radio employing 7×10 MHz band and 4×10² MHz band, a method using PHS and a method using a portable telephone employing 8×10² MHz band and 9×10² MHz band.

Note that the frequency employed for the wireless communication using radio waves is preferably not less than 3×10 MHz (in particular, not less than 1×10² MHz) in view of miniaturization of an antenna. Further, the frequency of radio waves is preferably 3×10² GHz or less (in particular, 3×10 GHz or less) in view of lowering the cost and the miniaturization of the communication circuit.

In addition, since it is possible to transmit the image data with a large capacity at a high speed when other devices do not perform communication using the same channel but not possible to transmit the image data when other devices are communicating with the same channel, it is preferable to configure so as to select a channel to be used from a plurality of channels.

As the method to perform communication using light, a method using an optical wireless LAN and a method using near-infrared rays according to IrDA standard are exemplified as the non-limiting examples, however, it is not limited thereto. As the example of the method using an optical wireless LAN, a method to connect a repeater to a wired LAN to communicate via an optical communication hub may be given.

The wireless communication repeater 6 has preferably a function as a charger for the cassette 5 and as a holder for the cassette 5 when it is not used.

For example, the wireless communication repeater 6 is provided with a connector, and the internal power source 51 of the cassette 5 is charged when the connector and the cassette 5 are connected to each other. In this regard, the wireless communication repeater 6 is preferably configured in such a structure that the cassette 5 is easily detached therefrom. In addition, the wireless communication repeater 6 is preferably in such a form that it holds the cassette 5 while charging the cassette 5. With such a configuration, the wireless communication repeater 6 preferably functions as a holder for the cassette 5 and as a charger as well.

In the X-ray source 4, a high voltage generation source 41 for generating high voltage and an X-ray tube 42 that generates X-rays when it is impressed with high voltage by the high voltage generation source 41 are installed. At the irradiation exit of the X-ray tube 42, an X-ray diaphragm device (not shown) for adjusting X-ray irradiation range is installed. Since the X-ray diaphragm device controls the X-ray irradiating direction in accordance with the control signals from the console, the X-ray irradiating range is adjusted corresponding to the radiography region. An X-ray source control unit 43 is installed in the X-ray source 4, and the high voltage generation source 41 and the X-ray tube 42 are connected to the X-ray source control unit 43, respectively. The X-ray source control unit 43 drives and controls each component of the X-ray source 4 based on the control signals transmitted from the console communication unit 14, that is, controls the high voltage generation source 41 and the X-ray tube 42.

As shown in FIG. 11, the cassette 5 has a housing 55, so that the cassette is configured such that the inside thereof is protected and is formed to be portable. For the housing 55, a light metal, such as aluminum and magnesium, is used as the material. Since such a light metal is used, the strength of the housing is ensured while reducing cost and weight.

Prior to X-ray radiography, the positions and directions of the cassette 5, the X-ray source 6 and a subject are adjusted and placed by an operator so that X-rays penetrate through the desired position of the subject and enters into the cassette. Then, the X-ray source 4 generates X-rays in response to the instruction from the console 1. Then, the X-rays penetrated through the subject from the X-ray source 4 enter into the cassette 5.

In the cassette 5, an internal power source 51, a cassette communication unit 52, a cassette control unit 53 and a panel 54 are installed. The internal power source 51, the cassette communication unit 52, the cassette control unit 53 and the panel 54 are connected to the bus in the cassette 5, respectively.

The internal power source 51 supplies electric power to the respective components installed in the cassette 5. The internal power source 51 is provided with a capacitor that is chargeable and is capable of dealing with electric power to be consumed at the time of radiography. Preferably, the capacitor is an electrolytic double-layer capacitor. As the internal power source 51, primary cells, such as manganese cells, nickel-cadmium cells, mercury cells and lead cells, for those which exchange of cells is required, or chargeable secondary batteries may be used.

When the capacity of the internal power source 51 is converted into pagination of X-ray images to be continuously acquired with the maximum size, preferably, it is four sheets or more (in particular seven sheets or more) in view of radiography efficiency.

Further, when the capacity of the internal power source 51 is converted into pagination of X-ray images to be continuously acquired with the maximum size, preferably, it is 100 radiographs or less (in particular 50 radiographs or less) in view of downsizing, reducing weight, and lowering cost.

The cassette communication unit 52 is configured such that it can radio-communicate with the console communication unit 14 via the wireless communication repeater 6 and is capable of transmitting and receiving signals between the cassette communication unit 52 and the console communication unit 14 and transmitting X-ray image data from the cassette communication unit 52 to the console communication unit 14.

The cassette control unit 53 controls the respective components installed in the cassette 5 based on the control signals that the cassette communication unit 52 has received.

The panel 54 outputs X-ray image data based on the X-rays that has penetrated through the subject. Note that the panel 5 according to this embodiment is an indirect-type flat panel detector (FPD).

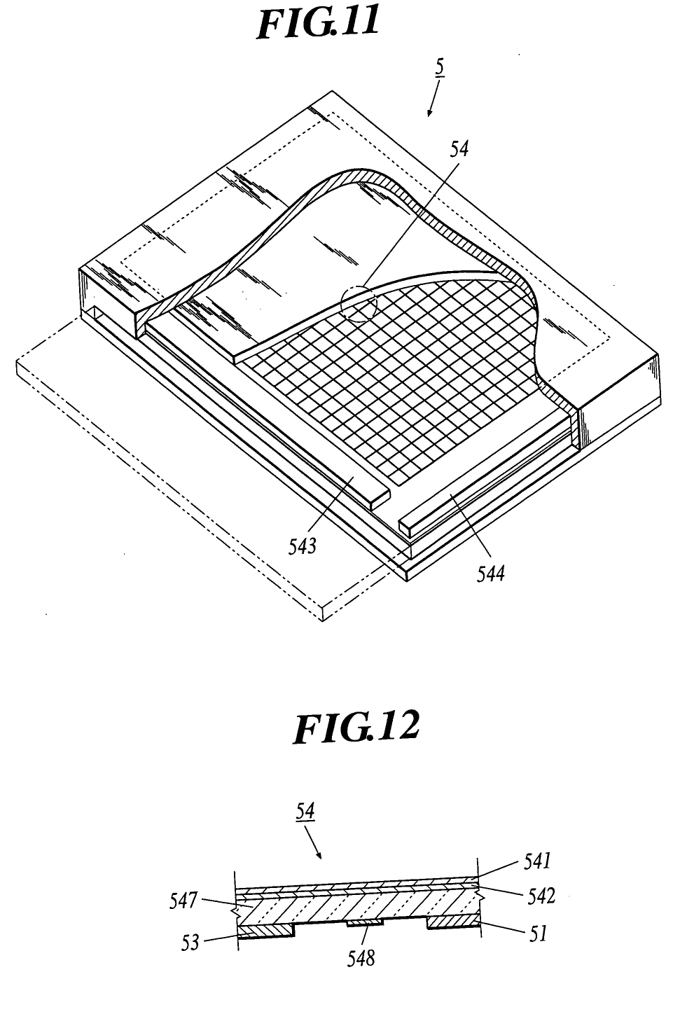

A perspective view illustrating the schematic structure of the cassette 5 is shown in FIG. 11, and a cross-section of the cassette 5 around the panel 54 is shown in FIG. 12.

Note that the examples shown in FIGS. 11 and 12 are explained in this embodiment, the present invention is not limited to theses examples, and scintillators having different thickness and type and panels having different image acquiring area can be used. With the increase in the thickness of the scintillator, the sensitivity thereof is getting higher, whereas with the reduction of the thickness of the scintillator, the spatial resolution capability thereof is getting higher. And, the spectral sensitivity differs depending on the types of the scintillators.

On the panel 54, a scintillator that detects the X-rays having passed through the subject and converts the detected X-rays into the fluorescence in the visible range (hereinafter referred to as “visible light”) is provided in layers.

The scintillator 541 contains a fluorescent substance as the main component. The scintillator 541 is a layer in which the dominant component of the fluorescent substance is excited (absorbed) by the irradiated X-rays and emits visible light by means of the recombination energy of the dominant component. The examples of the fluorescent substance include one which emits fluorescence by the dominant component such as CaWO₄ and CdWO₄, one which emits fluorescence by luminescence center added in the dominant component such as CsI:Tl and ZnS:Ag, and the like.

A protective layer is formed on the upper side of the scintillator 541. The protective layer protects the scintillator 541, completely covering over the upper and edge areas of the scintillator 541. Any material, as far as it has moisture-proof and protective effect on the scintillator 541, may be used for the protective layer. When a moisture-proof fluorescent substance (particularly an alkali halide, and more particularly fluorescent substance in cylindrical crystals) is used for the scintillator 541, it is preferable to use an organic film made of polyparaxylene, which is formed according to the CVD method disclosed, for example, in U.S. Pat. No. 5,469,305, an organic film made of a polymer containing silazane, such as polysilazane and polysiloxazane, or a polymer compound of the siloxazane type, and moisture-proof film such as an organic film produced according to the plasma polymerization method.

In the layer underneath the scintillator 541, a light detector 542 made from amorphous silicon exists in extending laminated state, and visible light emitted from the scintillator 541 is converted by the light detector 542 into electric energy and is then output.

The panel 54 preferably comprises pixels of 1000×1000 or more, (in particular 2000×2000 or more) in view of diagnosis efficiency based on X-ray images.

Moreover, the panel 54 preferably comprises pixels of 10000×10000 or less, (in particular 6000×6000 or less) in view of visibly-recognizable limit for an observer and image processing speed of X-ray images.

The size of the radiography area of the panel 54 has preferably an area of 10 cm×10 cm or more, (in particular 20 cm×20 cm or more) in view of diagnosis efficiency based on X-ray images.

Moreover, the size of the radiography area of the panel 54 has preferably an area of 70 cm×70 cm or less, (in particular 50 cm×50 cm or less) in view of convenience in handling as a cassette.

The size of one pixel in the panel 54 is preferably 40 μm×40 μm or more, (in particular, 70 μm×70 μm or more) in view of reduction of X-rays to be exposed.

Moreover, the size of one pixel in the panel 54 is preferably 200 μm×200 μm or less, (in particular, 160 μm×160 μm or less) in view of diagnosis efficiency based on X-ray images.

In this embodiment, the panel 54 comprises 4096×3072 pixels and has the radiography area of 430 mm×320 mm, and the size of one of the pixels is 105 μm×105 μm.

Now, the circuit configuration around the light detector 542 will be explained.

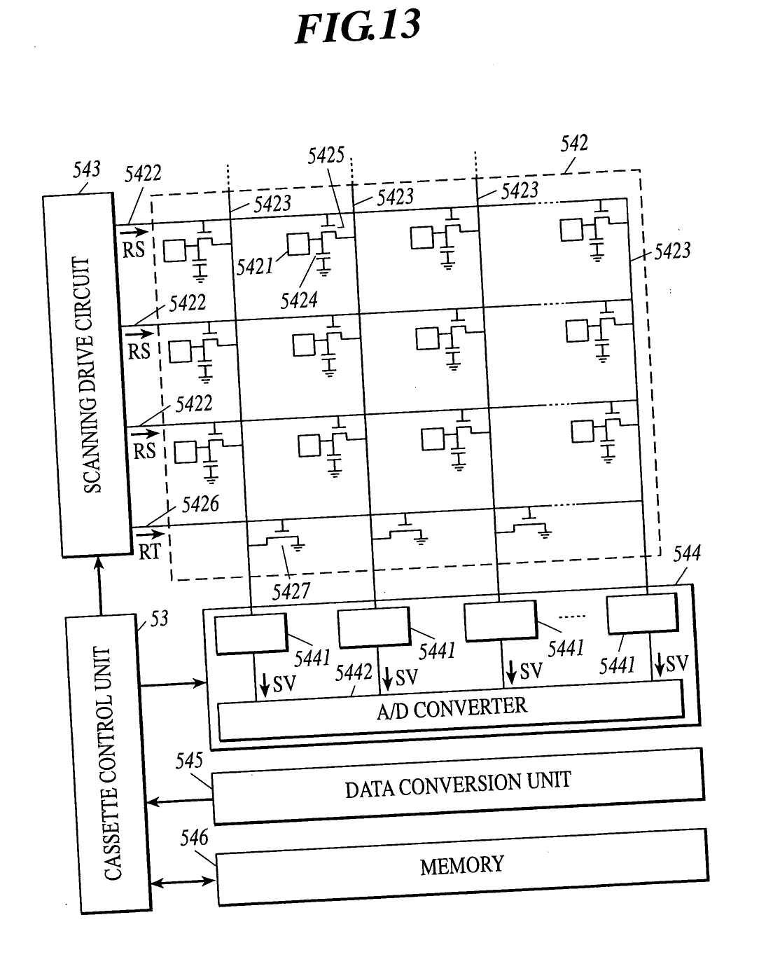

As shown in FIG. 13, the light detector 542 is installed two-dimensionally with collecting electrodes 5421 for reading out electric energy stored in correspondence to the intensity of the irradiated X-rays. The collecting electrode 5421 acts as an electrode at one end of a capacitor 5424, with which electric energy is stored in the capacitor 5424. Note that one collecting electrode 5421 corresponds to one pixel of the X-ray image data.

Between the collecting electrodes 5421 being adjacent to each other, a scanning line 5422 and a signal line 5423 are set. The scanning lines 5422 and the signal lines 5423 are orthogonally arranged.

To the capacitor 5424, a switching thin-film transistor 5425 (TFT, hereinafter referred to as transistor) for controlling the storage and reading of electric energy is connected. A drain electrode or source electrode of the transistor 5425 is connected to the collecting electrode 5421, and a gate electrode of the transistor is connected to the scanning line 5422.

When the drain electrode is connected to the scanning line 5422, the source electrode is connected to the signal line 5423, whereas when the source electrode is connected to the collecting electrode 5421, the drain electrode is connected to the signal line 5423. Further in the panel 54, for example, a transistor connected with the drain electrode for the reset is provided to the signal line 5423. The source electrode of the transistor 5427 is earthed. Further, the gate electrode is connected with a reset line 5426.

Note that the transistors 5425 and 5427 are preferably formed in a silicon laminating structure or comprise an organic semiconductor.

Further, to a scanning drive circuit 543, the reset line 5426 to which a reset signal RT is transmitted from the scanning drive circuit 543 is connected to be orthogonal to the signal line 5423.

To the reset line 5426, the gate electrode of the reset transistor 5427 that is turned on with the reset signal RT is connected. In the reset transistor 5427, the gate electrode is connected to the reset line 5426, whereas the drain electrode thereof is connected to the signal line 5423, and the source electrode thereof is earthed. When the source electrode is connected to the signal line 5423, the drain electrode is kept earthed.

When a reset signal RT is supplied from the scanning drive circuit 543 to turn on the reset transistor 5427 and a read-out signal RS is concurrently supplied from the scanning drive circuit 543 to turn on the transistor 5425, electric energy stored in the capacitor 5424 is released out of the light detector 542 via the transistor 5425. In the following, the release of electric energy stored in the capacitor 5424 to the exterior of the light detector 542 resulting from the supply of a reset signal RT is referred to as “Reset of the light detector 542”.

To the scanning line 5422, the scanning drive circuit 543 to supply a read-out signal RS to the scanning line 5422 is connected. The transistor 5425 connected to the scanning line 5422 to which a read-out signal RS has been supplied is turn on to read out electric energy stored in the capacitor 5424 connected to the transistor 5425, thereby supplying the electric energy to the signal line 5423. That is, by driving the transistor 5425, signals for every pixel in the X-ray image data can be produced.

To the signal line 5423, a signal reading circuit 544 is connected. To this signal reading circuit 544, electric energy stored in the capacitor 5424 and then read out to the signal line 5423 is supplied. To the signal reading circuit 544, a signal converter 5441 to supply a voltage signal SV proportional to the electric energy supplied to the signal reading circuit 544 to an A/D converter 5442 and an A/D converter 5442 for converting the voltage signal SV supplied from the signal converter 5441 into the digital signal and then supplying it to a data conversion unit 545 are provided.

To the signal reading circuit 544, a data conversion unit 545 is connected. The data conversion unit 545 produces X-ray image data based on the digital signal supplied from the signal reading circuit 544.

When image data with high resolution is not required or image data is required to be acquired promptly, the console control unit 13 transmits the received control signals, such as thinned-out signals, pixel average signals and region extraction signals, according to the radiography method selected by an operator. The cassette control unit 53 controls to execute the thinning-out, the pixel averaging, and the region extraction as described below according to the received control signals, such as thinning-out signals, pixel averaging signals and region extraction signals.

The thinning-out is performed by reading out only the uneven row or only the even row so that the number of pixels to be read out is reduced to one quarter of the whole number of pixels, or is reduced similarly to one ninth or one sixteenth of the whole number of pixels. Note that, however, the thinning-out method is not limited to the above-described methods.

The pixel average can be calculated by driving a plurality of scanning lines 5422 at the same time and then analog-adding two pixels in the same row direction. The calculation of the pixel average is not limited to the adding of two pixels. It can be easily acquired by performing analog-adding of the plural pixels in the columns direction of signal wire. Furthermore, for the adding in the rows direction, additional values of square pixels such as 2×2 can be acquired by digital-adding adjoining pixels after A/D conversion output and together with the above-described analog adding. With the above-described procedures, it is possible to read out data at a high speed without uselessly consuming the irradiated X-rays.

The region extraction has a method to limit the acquiring area of image data. In the region extraction procedure, it is configure such that the acquiring area of necessary image data is specified on basis of the instruction contents of the radiography method, the cassette control unit 53 alters the data acquiring range of the scanning drive circuit 543 based on the specified acquiring area, and the panel 54 drives the altered acquiring area.

To the data conversion unit 545, a memory 546 is connected. The memory 546 stores X-ray image data produced by the data conversion unit 545. Besides, data for gain correction is stored in the memory 546 beforehand.

The memory 546 is constructed with a RAM (Random Access Memory) and a nonvolatile memory. The memory 546 can write X-ray image data successively produced by the data conversion unit 545 into the RAM seriatim and then write into the nonvolatile memory in block. The nonvolatile memory comprises two or more memory parts, such as EEPROM and flash memory, and can write data into one memory part while deleting data from the other memory part.

As described above, since the cassette 5 has the memory 546 for temporarily storing the X-ray image data, it can once store the acquired X-ray image data. Therefore, it is needless to prolong X-rays radiography under the defective and/or disabled communication state until the communication state is recovered, and the cassette 5 can transmit the stored X-ray image data in the memory 546 from itself to the console 1 at a transmission speed according to the communication state between the cassette 5 and the console 1. Note that the capacity of the memory 546 is preferably four or more (in particular ten or more), as converted into the number of images of the maximum data size which can be stored, in view of efficiency of the radiography. In addition, the capacity of the memory 546 is preferably 1000 or less (in particular 100 or less), as converted into storable number of images of the maximum data size, in view of lowering the cost.

Underneath the layer of the light detector 542, a planar support 547 made from a glass substrate is provided, and the laminating structure of the scintillator 541 and the light detector 542 is supported by the support 547.

Underneath the support 547, an X-ray dose sensor 548 is provided. The X-ray dose sensor 548 detects the X-ray dose passed through the light detector 542. When the X-ray dose has reached to a predetermined dose, the X-ray dose sensor 548 transmits a predetermined X-ray dose signal to the cassette control unit 53. In this embodiment, amorphous silicon light-receiving element is used as the X-ray dose sensor 548. However, the X-ray dose sensor is not limited to the foresaid element. For example, an X-ray sensor that uses a light-receiving element made from crystalline silicon to directly detect X-rays, and a sensor that detects fluorescence by means of a scintillator may be used.

As described above, the cassette 5 is driven with electric power supplied from the internal power source 51 and is a portable type that does not need cables. Since the cassette communication unit 52 and the console communication unit 14 communicate to each other via a wireless communication, it is needless to pay attention during the radiography so that the cable does not coil around the subject while maintaining the engagement with the cassette 52, thereby improving operability and radiography efficiency.

Note that, although it is shown above that the console 1 is installed in the X-ray control room R2 as an example, the console 1 may be a portable terminal capable of carrying out wireless communication. In this case, the operation input unit 2 and the display unit 3 may be included in the console 1 being a portable terminal, or may be separately installed from and connectable to the console 1 being a portable terminal. Accordingly, when the display unit 3 is included in the console 1 being a portable terminal, the display screens 31 described in conjunction with FIGS. 2 to 10 are displayed on the display screen of a portable terminal.

Moreover, in a case where the console 1 is a portable terminal capable of carrying out wireless communication, the system is preferably configured such that a wireless communication repeater is also installed in the X-ray control room R2 and the console communication unit 14 can wirelessly communicate with both the wireless communication repeater 6 in the X-ray radiography room R1 and the wireless communication repeater in the X-ray control room R2, permitting the communication with cassette 5 from either the X-ray radiography room R1 or the X-ray control room R2. With such a configuration, an operator can check X-ray images by means of the cassette 5 and start image processing of X-ray image data while giving instruction as to radiography position, etc. to the subject not only from the X-ray control room R2, whereto it has been limited conventionally, but also from the X-ray radiography room R1. In addition, the time having been required in the past for moving between the X-ray radiography room R1 and X-ray control room R2 may be utilized for checking the X-ray images and starting the image processing of the X-ray image data. As a result, the whole efficiency of radiography in the overall X-ray radiography operation, in which the operational cycle starting from X-ray radiography until checking an X-ray image is repeated, can be improved.

In the above-described case, the wireless communication repeater 6 can detect the wireless communication state between the cassette 5 and the wireless communication repeater 6 through reduction in the received radio wave intensity in the wireless communication and the quantity of noise in the wireless communication band. In this case, the wireless communication repeater 6 transmits information on the wireless communication state between the cassette communication unit 52 and the wireless communication repeater 6 detected by the wireless communication repeater 6 to the console communication unit 14. When the console communication unit 14 has received the information, the console control unit 13 detects the wireless communication state. On the other hand, the console communication unit 14 can detect the wireless communication state between the console communication unit 14 and the wireless communication repeater 6 through reduction in the received radio wave intensity in the wireless communication and the quantity of noise in the wireless communication band.

The detection of the wireless communication state may be achieved by detecting the communication execution speed. In this case, the wireless communication execution speed between the cassette 5 and the wireless communication repeater 6 and the wireless communication execution speed between the wireless communication repeater 6 and the console communication unit 14 may be detected separately by the wireless communication repeater 6, the wireless communication execution speed of the wireless communication between the cassette 5 and the wireless communication repeater 6 and the wireless communication between the wireless communication repeater 6 and the console communication unit 14 in total may be detected by the wireless communication repeater 6, or the overall wireless communication execution speed from the cassette 5 to the console communication unit 14 including the wireless communication between the cassette 5 and the wireless communication repeater 6 and the wireless communication between the wireless communication repeater 6 and the console communication unit 14 may be detected by the console communication unit 14. Then, the console control unit 13 detects the wireless communication state based on the information on the communication execution speed.

When the console control unit 13 has detected that the wireless communication between the cassette communication unit 52 and the wireless communication repeater 6 is in disabled state, that is, when the console control unit 13 has detected not only that the wireless communication is in disabled state but also that the wireless communication between the console communication unit 14 and the wireless communication repeater 6 is in disabled state, the console control unit 13 controls the display control unit 11 so that it displays an indication stating that the display unit 3 is in disabled communication state.

While it is detected that the console communication unit 14 is receiving X-ray image data from the cassette 5, that is, in a case where the console communication unit 14 is receiving X-ray image data from the cassette 5, the console control unit 13 controls the display control unit 11 so that the display unit 3 shows an indication stating that the console communication unit 14 is receiving X-ray image data. However, in a case where the console control unit 13 has detected that the wireless communication is in disabled state while the display unit 3 is showing the indication of receiving X-ray image data, the console control unit 13 controls the display control unit 11 so that it interrupts the indication of receiving X-ray image data.

Alternatively, the console control unit 13 may control the display control unit 11 so that the display unit 3 shows different indications for the case that the console control unit 13 has so detected that the wireless communication between the cassette communication unit 52 and the wireless communication repeater 6 is in defective state and for the case that the console control unit 13 has so detected that the wireless communication between the console communication unit 14 and the wireless communication repeater 6 is in defective state.

Next, the operation of the X-ray radiography system in the first embodiment according to the present invention will be explained in the following.

The cassette control unit 52 controls the scanning drive circuit 543 to maintain in turned-off state until receiving a radiography preparation instruction signal from the console control unit 13. In order to maintain in the turned-off state, the potentials of the scanning lines 5422, the signal lines 5423 and the reset lines 5426 are made at the same potential, and no bias is impressed to the collecting electrodes 5421. Further, the power source for the signal reading circuit 544 may be maintained in off state, and the potentials of the scanning lines 5422, the signal lines 5423 and the reset lines 5426 may be set at GND potential.

The state where no bias is impressed to the scanning drive circuit 543 and the signal reading circuit 544 includes the radiography standby mode and the sleep mode.

Note that, in the radiography standby mode, it is preferable for further saving electric energy not to impress bias potential to a photodiode and not to supply electric energy to the scanning drive circuit 543 and the signal reading circuit 544, because both of the scanning drive circuit 543 and the signal reading circuit 544 can start quickly. Further, in the radiography standby mode, since no signal is generated, it is preferable for further saving electric energy not to supply electric power to the data conversion unit 545.

It is preferable to provide the sleep mode which consumes further less electric energy than that in the radiography standby mode. It is preferable to shift to the sleep mode after completely transmitting the acquired image to the console 1. In the sleep mode, it is preferable to leave only requisite functions in order to start into the radiography standby mode in response to an instruction from the console 1, and to interrupt the high-speed transmission function or the overall transmission function of the cassette communication unit 52 and power supply to a memory. More specifically, it is preferable in the sleep mode not to impress bias potential to a photodiode and not to supply electric power to the high-speed transmission function or the overall transmission function of the scanning drive circuit 543, the signal reading circuit 544, the data conversion unit 545, the memory 546 and the cassette communication unit 52. In this procedure, it is possible to further save useless consumption of electric power.

As described above, since the potentials of the scanning lines 5422, the signal lines 5423 and the reset lines 5426 are made to the same potential, no bias potential is impressed to the collecting electrodes 5421, that is, no voltage is substantially impressed to a plurality of pixels, in the state under the control of the radiography standby mode and the sleep mode in which electric power consumption per unit time is less than that in the photographable state, the deterioration of the plurality of pixels due to the voltage substantially impressed to PD and TFT can be suppressed. Additionally, useless consumption of electric energy can be saved.

Then, for example, when the first switch of X-ray irradiation switch is turned on and the input unit 12, to which predetermined items such as information on a subject and radiography are input via the operation input unit 2, has received instruction contents for radiography and order information from HIS/RIS71, the console control unit 13 determines the radiography condition based on the instruction contents made by the operator and the order information from HIS/RIS71 and transmits a radiography preparation instruction signal based on the radiography condition to the X-ray source control unit 43 and the cassette control unit 53 via the console communication unit 14 so that the system is shifted to the radiography capable state.

The X-ray source control unit 43, upon receipt of the radiography preparation instruction signal, drives and controls the high voltage generation source 41 to cause it to be shifted to the state of impressing high voltage to the X-ray tube 42.

The cassette control unit 53 shifts to the radiography capable state in response to the receipt of the radiography preparation instruction signal. Specifically, the cassette control unit 53 repeats the resetting of the whole pixels at a fixed interval until a radiography instruction is input under the radiography capable state to prevent electric energy from being stored in the capacitor 5424 by dark current. Besides, since the time during which the radiography capable state continues is unknown, the fixed interval is set so as to be longer than the interval at the time of radiography and the time of the transistor 5425 to be kept turned on is set so as to be shorter than that at the time of radiography. With such settings, reading out operation that imposes load to the transistor 5425 is reduced under the radiography capable state. Then, after completing the shift to the radiography capable state, the cassette control unit 53 transmits a radiography capable state shift signal to the console 1. The console control unit 13, in response to the receipt of the radiography capable state shift signal, controls the display control unit 11 so that the display unit 3 displays an indication of cassette radiography capable state that indicates the state that the cassette has been shifted to the radiography capable state.

When a radiography instruction is input into the console control unit 13, the console control unit 13 determines a radiography condition based on the instruction contents made by an operator and the order information given from HIS/RIS71, etc. and transmits radiography condition information on the radiography condition to the X-ray source control unit 43 and the cassette control unit 53 via the console communication unit 14.

When the console control unit 13 has received an X-ray irradiation instruction, for example, to turn on the X-ray irradiation second switch from an operator, it transmits a radiography instruction signal to the cassette control unit 53 in the cassette 5. Then, after the X-ray irradiation instruction was input to the console control unit 13, the console control unit 13 controls the X-ray source 4 and the cassette 5 to perform radiography while synchronizing.

Upon receipt of the radiography instruction signal, the cassette control unit 53 resets the panel 54. Then, the panel 54 is shifted to a state capable of storing electric energy. Specifically, the panel 54 performs refreshing and resetting of the whole pixels dedicated for a radiography sequence predetermined times and resetting of the whole pixels dedicated for electric energy storing state to be shifted to the electric energy storing state. Since the period of time from the exposure request until the completion of radiography preparation is practically required to be short, the resetting of the whole pixels dedicated for the radiography sequence is performed. In a case where an exposure request is raised at any state in driving under the radiography capable state, the period of time from the exposure until the completion of radiography preparation can be shortened by immediately starting the radiography sequence driving to thereby improve the maneuverability.

When the panel 54 has shifted to a state where it can store electric energy, the cassette control unit 53 transmits a preparation end signal of the cassette 5 to the console communication unit 14. The console communication unit 14, upon receipt of the preparation end signal, transmits the preparation end signal of the cassette 5 to the console control unit 13.

When the console control unit 13 has been in a state of having received the preparation end signal of the cassette and also in a state of having received an X-ray irradiation instruction, the console control unit 13 transmits an X-ray irradiation signal to the X-ray source 4. The X-ray source control unit 43, upon receipt of the X-ray irradiation signal, drives and controls the high voltage generation source 41 to impress high voltage to the X-ray tube 42 to thereby generate X-rays from the X-ray source 4. The irradiation range of X-rays generated from the X-ray generation source 5 is adjusted by means of the X-ray diaphragm device provided to the X-ray irradiation opening to irradiate the subject.

Further, the console control unit 13 controls the display control unit 11 so that the display unit 3 displays an under-X-ray radiography indication that indicates that the system is under radiography.

X-rays having passed through the subject enter into the cassette 5. The X-rays having entered into the cassette 5 are converted to visible light by means of a scintillator 541.

The X-ray dose sensor 548 detects the X-ray dose having been irradiated to the cassette 5. Then, when the irradiated X-ray dose has reached to a predetermined dose, the X-ray dose sensor 548 transmits a predetermined X-ray dose signal to the cassette control unit 53. The cassette control unit 53, upon receipt of the predetermined X-ray dose signal, transmits an X-ray end signal to the console communication unit 14 via the wireless communication repeater 6. The console communication unit 14, upon receipt of the X-ray end signal, transmits an X-ray end signal to the console control unit 13 and transmits simultaneously an X-ray irradiation stop signal to the X-ray source control unit 43. The X-ray source control unit 43, upon receipt of the X-ray irradiation stop signal, drives and controls the high voltage generation source 41, and the high voltage generation source 41 stops to impress high voltage to the X-ray tube 42. Then, the generation of X-rays discontinues.

The cassette control unit 53, upon receipt of the X-ray irradiation end signal, drives and controls the scanning drive circuit 543 and the signal reading circuit 544 based on the X-ray irradiation end signal. The scanning drive circuit 543 reads out electric energy acquired by the light detector 542 and inputs the acquired electric energy to the signal reading circuit 544. The signal reading circuit 544 converts the input electric energy into the digital signals. Then, the data conversion unit 545 configures the digital signals into the image data. The memory 546 temporarily stores the image data configured by the data conversion unit 545.

Subsequently, the cassette control unit 53, following to acquiring the image data, acquires image data for correction use. The image data for correction use is dark image data to which X-ray irradiation is not applied and is used for the correction of the image data in order to acquire X-ray images with high quality. The acquiring method of the image data for correction use is the same as the acquiring method of image data, except no that X-rays is irradiated. The storing time of electric energy is set so that the storing time at acquiring the image data is equal to the storing time at acquiring the image data for correction use. In this connection, the storing time of electric energy is defined as the time passing from the completion of reset operation, that is, from turning the transistor 5425 off, which has been on during resetting, until turning the transistor 5425 on in order to read out electric energy. Therefore, the timing of starting electric energy storing and electric energy storing time for the respective scanning lines 5422 are different from one to another.

The data conversion unit 545 performs the offset correction of the composed image data based on the acquired image data for correction use and subsequently performs the gain correction based on the data for the gain correction that is acquired beforehand and is stored in the memory 546. In a case of a panel configured with dead pixels and a plurality of small panels, the images are interpolated in series so that no sense of incongruity is produced in the joint portions of small panels, whereby completing the correction processing associated with the panel. In this embodiment, though the data conversion unit 545 is separate from the cassette control unit 53, the cassette control unit 53 may also be used as the data conversion unit 545.

Then, when the X-ray image data is compensated and temporarily stored in the memory 546, the cassette control unit 53 transmits the X-ray image data through the cassette communication unit 52, the wireless communication repeater 6 and the console communication unit 14.

As described above, since the cassette 5 is provided with the memory 546 that receives electric power from the internal power source 51 to function, and temporarily stores the X-ray image data acquired by the panel 54 and transmitted by the cassette communication unit 52, the cassette 5 can function for data generation and as an accumulator between the cassette and the console, and forwards the X-ray image data from the cassette to the console collaterally to the communication state between the cassette and the console. Particularly, since the memory is a RAM, the data generation may be effected satisfactorily, even though the data is acquired from the panel 54 at a high speed.

When the X-ray image data is radio-transmitted, it is preferable to encode the X-ray image data and then to transmit. Specifically, it is preferable to provide the cassette 5 with an encoding section for encoding the X-ray image data to be transmitted and to provide the console 1 with a decoding section for decoding the encoded X-ray image data. The cassette control unit 53 or the cassette communication unit 52 may also be used as such an encoding section, or an encoding section may be installed separately therefrom. Besides, the wireless communication repeater 6, the console communication unit 14 or the console control unit 13 may also be used as such a decoding section, or a decoding section may be installed separately therefrom.

As examples of technologies suitable to the above-described encoding, WEP (Wired Equivalent Privacy: Encoding using common key having key length of 64 bits or 128 bits) defined in IEEE 802.11, TKIP (Temporal Key Integrity Protocol: Encoding effected by automatically altering keys) defined in IEEE 802.1 μl, WPA (Wi-fi Protected Access: Encoding combining TKIP and IEEE 802.1x), and AES (Advanced Encryption Standard) can be given. However, the encoding according to the present invention is not limited to those described above.

Besides, it is preferable to limit the access of other device to the cassette communication unit 52, the console communication unit 14 and the wireless communication repeater 6. As examples of the access limitation function, SSID (Service Set Identifier: Inherent ID for a device to be connected, a packet of which SSID contained in the header thereof does not accord is ignored), MAC (Media Access Control), address (address inherent to LAN card) filtering function (connection is allowed for only the terminals having registered MAC addresses), ANY connection refusal function (function to be set to an access point, when SSID setting of a client is set as “ANY”, function to refuse connection to an access point, this function is contrary to the general case, where connection to every access points having SSID is allowed if the SSID setting of a client is “ANY”), function not to include SSID in beacon signals, and user authentication by RADIUS server defined in IEEE 802.1x (all communications from unauthenticated terminals are refused, only authenticated users are allowed to communicate) can be given. However, the access limitation function according to the present invention is not limited to the above examples.

Further, it is preferable to compress the X-ray image data in the cassette 5 and to decompress them at the console 1 side in order to improve the communication speed. Specifically, it is preferable to provide a compressing section for compressing X-ray image data to be transmitted in the cassette 5 and a decompressing section for decompressing the compressed X-ray image data in the console 1. However, the cassette control unit 53 or the cassette communication unit 52 may also be used as such a compressing section, or a compressing section may be installed separately therefrom. Likewise, the wireless communication repeater 6, the console communication unit 14 or the console control unit 13 may also be used as such a decompressing section, or a decompressing section may be installed separately therefrom.

In this encoding process, it is preferable to compress the data, then to encode, followed by decoding, and then to decompress the compressed data. Specifically, it is preferable to encode by the encoding section the X-ray image data compressed by the compressing section, and then to decompress by the decompressing section the X-ray image data decoded by the decoding section.

The console control unit 13, upon receipt of X-ray image data, stores the data temporarily in the image storage unit 16. Then, the console control unit 13 controls the image processing unit 15 so that it prepares thumbnail image data from the X-ray image data temporarily stored in the image storage unit 16. The display control unit 11 controls the display unit 3 so that it displays the thumbnail images based on the prepared thumbnail data.

Subsequently, the image processing unit 15 performs the image-processing of the image data based on the instruction contents made by an operator and the order information from HIS/RIS71 and the like. The image-processed image data is displayed on the display unit 3 and simultaneously transmitted to the image storage unit 16 and then stored there as image data. Further, the image processing unit 15 image-processes the image data again in accordance with the instruction of an operator, and the image processing results of the image data are displayed on the display unit 3. The network communication unit 18 forwards the image data to the external devices on the network including the imager 72, the image processing terminal 73, the viewer 74, the file server 75, etc. The external devices, upon receipt of the image data from the console 1, start to effect their functions in a collateral way. Specifically, the viewer 72 records the X-ray image data in an image recording medium such as a film. The image processing terminal 73 performs image processing of the X-ray image data and processing for CAD (Computer Aided Diagnosis) and store the processed data in the file server 75. The viewer 74 displays the X-ray images based on the X-ray image data. The file server 75 stores the X-ray image data.

As described above, the cassette control unit 53 performs controlling to alter the power supply state of the cassette 5 at proper timing to a radiography capable state, a state under control of one or plural radiography standby modes, where consumption of electric power is less than the radiography capable state, or a state under control of the sleep mode, where consumption of electric power is further less. Further, the cassette control unit 53, in association with the timing of controlling the electric power supply change of the cassette 5, controls the cassette communication unit 52 so that it transmits the electric power supply state information indicating the electric power supply state of the cassette 5.

Since it is possible to control the console control unit 13 with the electric power supply state information indicating electric power supply state of the cassette 5 received by the console communication unit 14, the radiography can be controlled in a good condition and the efficiency in the radiography can be improved. Furthermore, since the electric power supply state can be displayed on the display unit 3 depending on the electric power supply state information, an operator can determine whether the cassette 5 can perform X-ray radiography immediately or not to improve the efficiency in radiography by, for example, performing radiography with the other cassette or modality before or later.

Now, the operation when detecting the communication state of wireless communication in the first embodiment according to the present invention will be explained in the following.

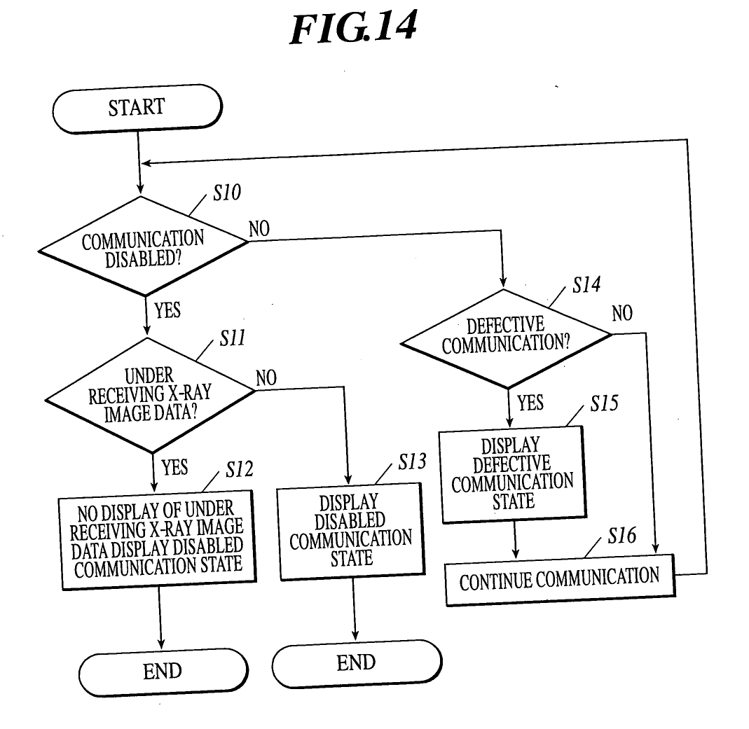

FIG. 14 shows a flowchart for the detection of communication state between the cassette communication unit and the wireless communication repeater.

The console control unit 13 uses the detection results acquired by the console communication unit 14 or the wireless communication repeater 6 to detect the communication state of wireless communication between the cassette communication unit 52 and the wireless communication repeater 6. The console control unit 13, upon detecting the disabled state of wireless communication between the cassette communication unit 52 and the wireless communication repeater 6 (Step S10: Yes), determines whether the console communication unit 14 is receiving X-ray image data or not (Step S11). In a case that it was determined that the console communication unit 14 is receiving X-ray image data (Step S11: Yes), the console control unit 13 controls the display control unit 11 so that the display unit 3 interrupts to show the display indicating that the console communication unit 14 is receiving X-ray image data and shows a display indicating that the system being in disabled state (Step S12). On the other hand, in a case that the console control unit 13 determined that the console communication unit 14 is not receiving X-ray image data (Step S11: No), the console control unit 13 controls the display control unit 11 so that the display unit 3 shows a display indication that the system being in disabled state (Step S13).

In a case that the console control unit 13 did not detect a disabled communication state between the cassette communication unit 52 and the wireless communication repeater 6 (Step S10: No), the console control unit 13 determines whether the wireless communication between the cassette communication unit 52 and the wireless communication repeater 6 is disabled or not (Step S14). When the console communication unit 14 has detected defective wireless communication state between the cassette communication unit 52 and the wireless communication repeater 6 (Step S14: Yes), the console control unit 13 controls the display control unit 11 so that the display unit 3 shows a display indicating being in defective communication state (Step S25). In this case, the wireless communication between the cassette communication unit and the wireless communication repeater continues (Step S16) and then returns to Step S10. In a case that the console communication unit 52 did not detect the disabled communication state between the cassette communication unit 52 and the wireless communication repeater 6 (Step S14: No), the wireless communication between the cassette communication unit 52 and the wireless communication repeater 6 continues (Step S16) and then returns to Step S10.

As described above, since the X-ray radiography system 1000 in this embodiment controls the display unit 3 installed at the console 1 side to display an indication of being in disabled communication state when it has detected the disabled communication state with the cassette 5, an operator can notice the disabled communication state with the display unit 3 installed at the console 1 side. With such an arrangement, an operator can take a proper countermeasure to recover the system to a state capable of performing communication and to check X-ray images. Further, in a case that the system has detected the defective communication state with the cassette 5, it controls the display unit 3 to show a display indicating the defective communication state. Therefore, an operator can notice the defective communication state with the display unit 3 installed at the console 1 side. With this arrangement, an operator can take immediately a proper countermeasure to recover the communication state to a good condition and to check X-ray images quickly or proceed preferentially to the other tasks. Hence, the efficiency in the radiography operation in total is improved. In addition, since an operator can notice with the display unit 3 installed at the console 1 side the disabled and defective communication states, an operator can take a proper countermeasure immediately depending on the disabled and defective communication states.

In a case of during reception of the X-ray image data from the cassette 5, a display indicating that the X-ray image data is under receiving is shown on the display unit 3. Therefore, an operator can notice that the X-ray image data is under receiving with the display unit 3 installed at the console 1 side from the cassette 5. Further, when the system has detected the disabled communication state during the display indicating that X-ray image is under receiving has been shown on the display unit 3, the system controls to interrupt the display of X-ray image data being under receiving and to show a display of disabled communication state.

Therefore, an operator can notice the disabled communication state without confusion as to whether X-ray image data is under receiving or communication is disabled, and take immediately a proper countermeasure to recover the system to the state capable of performing communication and to check the X-ray images.

Note that, in this embodiment, although the example comprising the panel 54 having pixels of 4096×3072 is given, it is also possible to replace the panel 54, for example, with four pieces of smaller panels each having pixels of 2048×1536. With such a configuration using plural small panels, though it is required to assemble the four panel to form into one panel, it has advantages because the yield for the respective panel is improved, and as a result the yield as a whole is thus improved, which leading to lowering the cost.

Besides, in this embodiment, though the example to read out electric energy of the irradiated X-rays using the scintillator 541 and the light detector 542 is given, the present invention is not limited to such an example, and light detectors capable of directly converting X-rays into electric energy can also be applied. For example, an X-ray-to-electric-energy conversion unit using amorphous Se, PbI₂, etc. and an X-ray detector comprising amorphous silicon TFT, etc. may also be used.

Besides, in this embodiment, through the example in which the A/D converter 5442 is installed in the signal reading circuit 544 is given, it is not limited in the present invention to such an example, and a plurality of A/D converters may also be applied. The number of the A/D converters to be used is preferably four or more, particularly eight or more, in order to shorten the time for reading images to acquire a desired S/N ratio.

The number of the A/D converters to be used is preferably 64 or less, particularly 32 or less, in view of lowering the cost and the downsizing. With such a number, it is possible to avoid the analog signal band and the A/D conversion rate from being uselessly large.

Beside, in this embodiment, the example to use the support 547 made from glass is given, it is not limited in the present invention to such an example, and supports made from resins, metals, etc. may also be applied.

Besides, in this embodiment, the example wherein one cassette 5 is collaterally installed with respect to one console 1 is given, it is not limited in the present invention to such an example, and the installation ratio for the cassette and the console to be used collaterally may also be 1 to M, N to 1, or N to M (N, M are natural numbers of two or more). In this concern, it is preferable to establish a network between the cassette and the console, to reserve the collateral relation of the cassette and console in a collateral relation information reservation section, to establish the collateral relation information reservation section on the network or within the console and to control the cassette with the console.

Though it is needless to say that this embodiment may be configured such that, in both of the console 1 and the cassette 5, a storing medium having recorded a software program for realizing the functions specified in the above-described examples is supplied to the system or the device, and a computer (or CPU and MPU) in the system or device reads out the contained program in the storing medium and executes it. Further, as the storing medium for storing programs and the like, a nonvolatile memory, a volatile memory backed up with a power source, a ROM memory, an optical disk, a hard disk, a magnet-optical disk and the like may be used.

It is also needless to say that not only the case where the functions specified in the foresaid examples are realized by executing the program read out by a computer, but also the case where an OS (basic system or operating system) working on a computer executes a part or the whole of the practical processing based on the instructions of the program to thereby realize the functions specified in the foresaid examples are also included in this embodiment.

Still further, it is needless to say that the case where a program read out from a storing medium is written into a function-expanded board inserted into a computer or a memory provided to a function-expanded unit connected to a computer, and then, a CPU and the like provided to the function-expanded board or function-expanded unit executes a part or the whole of practical processing based on the instructions of the program code to thereby realize the functions specified in the foresaid examples is also included in this embodiment.

In this concern, such a program may be an externally-provided program through a network or a line. Then, when using the externally-provided program, the program may be stored in a storing medium including a nonvolatile memory, a volatile memory backed up with a power source, an optical disk, a magnetic disk such as a hard disk, a magnet-optical disk and the like.

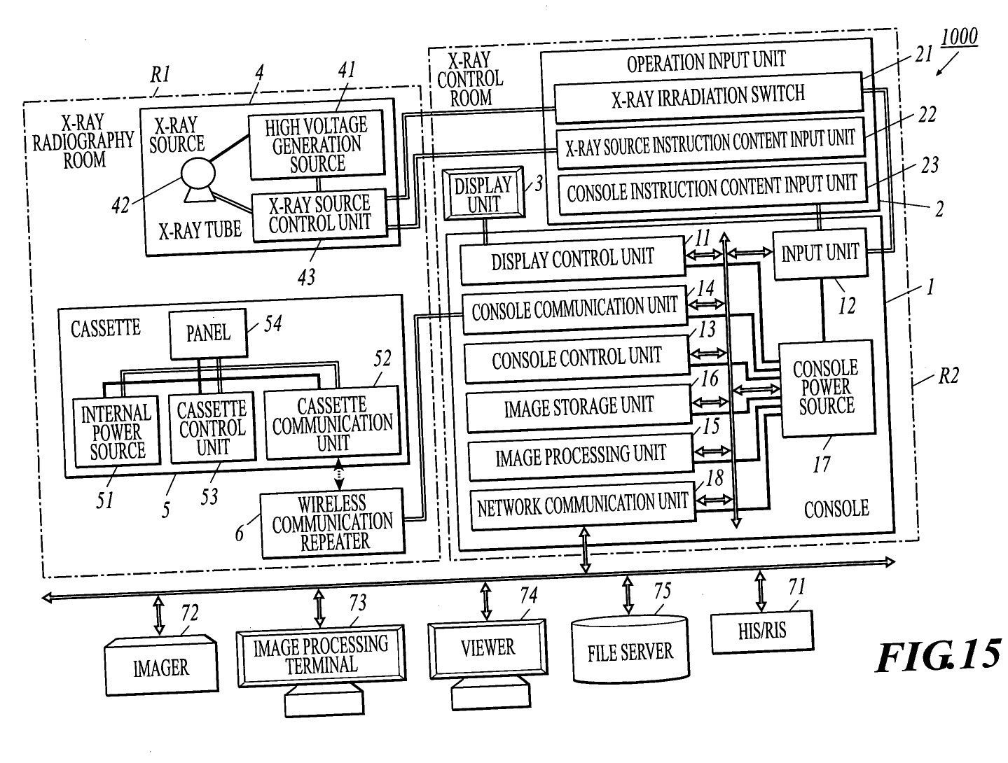

Next, the second embodiment of the X-ray radiography system according to the present invention will be explained in the following with reference to FIG. 15.

Note that, in the second embodiment, the configuration of the operation input unit is different from that in the first embodiment. The operation input unit comprises an X-ray irradiation switch, an X-ray source instruction content input section, and a console instruction content input section, wherein the X-ray irradiation switch and the X-ray source instruction content input section are connected with an X-ray source control unit and the console instruction content input section is connected with the input section of the console. Besides, a console communication unit is different from that in the first embodiment, the console communication unit is connected with a wireless communication repeater but not with the X-ray source control unit. The other configurations except the described hereinabove are same as the counterparts in the first embodiment.

In the second embodiment, the operation input unit and the X-ray source control unit will be explained mainly, and like reference symbols are given to like components to those which described in the first embodiment, whereby omitting the detail explanation for them.

In FIG. 15, the schematic configuration of the X-ray radiography system 1000 according to the second embodiment is shown.

As shown in FIG. 15, the operation input unit 2 includes an X-ray irradiation switch 21 with which an operator inputs radiography preparation instruction and radiography instruction, an X-ray source instruction content input unit 22 with which an operator inputs instruction contents to the X-ray source control unit, and a console instruction content input unit 23 with which an operator inputs instruction contents to the console. The instruction contents include X-ray radiography conditions, such as X-ray tube voltage, X-ray tube current and X-rays irradiation time, X-ray radiography conditions, such as radiography timing, radiography region and radiography manner, image processing conditions, image output conditions, cassette selection information, order selection information, subject ID and the like.

To the X-ray irradiation switch 21, the X-ray source control unit 43 and the input unit 12 are connected, respectively. The X-ray irradiation switch 21 includes a first switch for inputting radiography preparation instruction and a second switch for inputting radiography instruction, and the instruction made by the X-ray irradiation switch 21 is input to the X-ray source control unit 43 and the input unit 12. It is configured so as to input the instruction via the first switch and to then input via the second switch.

The X-ray source control unit 43 is connected to the X-ray source instruction content input unit 22. The X-ray source control unit 43 drives and controls the high voltage generation source 41 and the X-ray tube 42 based on an instruction content input from the X-ray source instruction content input unit 22.

The input unit 12 is connected to the console instruction content input unit 23. The instruction content input to the input unit 12 is transmitted to the console control unit 13. The console control unit 13 drives and controls the console 1 and the cassette 5 based on the received instruction content.

Next, the operation carried out by the X-ray radiography system of the second embodiment according to the present invention will now be explained.

An operator pushes down the first switch of the X-ray irradiation switch 21 to input a radiography preparation instruction. The X-ray source control unit 43 drives and controls the high voltage generation source 41 to cause the X-ray tube to be shifted to a high-pressure-impressing state based on the radiography preparation instruction made by the first switch. The console communication unit 13 transmits a radiography preparation instruction to the cassette 5 via the console communication unit 14 and the wireless communication repeater 6 based on the radiography preparation instruction input to the input unit 12 by the first switch. The cassette control unit 53 repeats resettings at a predetermined interval until the radiography instruction is input in order to prevent electric energy caused by dark current from being stored in the capacitor 5424.

An operator pushes down the second switch of the X-ray irradiation switch 21 to input a radiography instruction. The X-ray source control unit 43 drives and controls the high voltage generation source 41 to impress high voltage to the X-ray tube 42 to thereby cause it to generate X-rays.

The console control unit 13 drives and controls the cassette 5 to perform radiography based on the radiography preparation instruction input from the input unit 12 by the first switch with X-rays irradiated from the X-ray source 4.

The X-rays irradiated from the X-ray source 4 penetrate a subject and enter into the cassette 5. Image data is acquired based on the incident X-rays to the cassette 5, and the image data is then transmitted to the console 1 through the wireless communication repeater 6 and the console communication unit 14.

As described above, in the X-ray radiography system 1000 in the second embodiment, since the console communication unit 13 can detect disabled communication state between the console communication unit 14 and the cassette 5 to display the disabled communication, an operator can notice the disabled communication on the display unit 3 to thereby improve the efficiency of the radiography operation.

What is claimed is:

1. A radiography system having a console,
wherein the console comprises:
a console communication unit to communicate via wireless communication with a cassette, the cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit; and
a console control unit to control a display unit to display an indication informing that the wireless communication is in defective state when the console control unit has detected that the wireless communication is in defective state.

2. The radiography system of claim 1, further including a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit.

3. The radiography system of claim 1, further comprising a wireless communication repeater capable of communicating with the cassette communication unit, wherein the console communication unit is capable of communicating with the wireless communication repeater.

4. The radiography system of claim 3, wherein the console is a portable terminal in which the console communication unit communicates with the wireless communication repeater via a wireless communication.

5. The radiography system of claim 2, wherein the cassette includes a memory for temporarily storing radiograph data.

6. The radiography system of claim 2, wherein the cassette includes the radiograph acquiring unit, the cassette communication unit and an internal power source to supply electric power to the cassette control unit and is a portable type with no cable.

7. The radiography system of claim 6, wherein the cassette control unit controls the cassette communication unit to transmit electric power supply state information indicating an electric power supply state to be supplied to the radiograph acquiring unit to the console, and the console control unit controls the display unit to display an indication depending on the electric power supply state information received by the console communication unit.

8. A radiography system having a console,
wherein the console comprises:
a console communication unit to communicate via wireless communication with a cassette, the cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit; and
a console control unit to control a display unit to display an indication informing that the wireless communication is in disabled state when the console control unit has detected that the wireless communication is in disabled state.

9. The radiography system of claim 8, further including a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit.

10. A radiography system of claim 8, wherein the console control unit controls the display unit to display an indication informing that the wireless communication is in defective state when the console control unit has detected that the wireless communication is in defective state.

11. The radiography system of claim 9, further comprising a wireless communication repeater capable of communicating with the cassette communication unit, wherein the console communication unit is capable of communicating with the wireless communication repeater through a communication cable.

12. The radiography system of claim 11, wherein the console is a portable terminal in which the console communication unit communicates with the wireless communication repeater via a wireless communication.

13. The radiography system of claim 9, wherein the cassette includes a memory for temporarily storing radiograph data.

14. The radiography system of claim 9, wherein the cassette includes the radiograph acquiring unit, the cassette communication unit and an internal power source to supply electric power to the cassette control unit and is a portable type with no cable.

15. The radiography system of claim 14, wherein the cassette control unit controls the cassette communication unit to transmit electric power supply state information indicating an electric power supply state to be supplied to the radiograph acquiring unit to the console, and the console control unit controls the display unit to display an indication depending on the electric power supply state information received by the console communication unit.

16. A radiography system having a console,
wherein the console includes
a console communication unit to communicate via wireless communication with a cassette, the cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit; and
a console control unit to control a display unit to display an indication informing that the radiograph data is under reception when the console communication unit has been receiving the radiograph data from the cassette and causing the display unit to stop displaying the indication informing that the radiograph data is under reception when the console control unit has detected that the wireless communication is in disabled state while causing the display unit to display the indication informing that the radiograph data is under reception.

17. The radiography system of claim 16, further including a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit.

18. The radiography system of claim 16, wherein the console control unit controls the display unit to display an indication notifying that the wireless communication is in the disabled state when the console control unit has detected that the wireless communication is in the disabled state.

19. A program to make a computer for a console execute steps comprising:
a step to detect whether the wireless communication is in disabled state or not; and
a step to control the display unit to display an indication of disabled state when the wireless communication is detected as being in disabled state,
wherein the computer is capable of controlling a console communication unit to communicate via a wireless communication with a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit, and
the computer is capable of controlling a display unit.

20. A program to make a computer for a console execute steps comprising:
a step to detect whether the wireless communication is in defective state or not; and
a step to control a display unit to display an indication of defective communication state when the wireless communication is detected as being in defective state,
wherein the computer is capable of controlling a console communication unit to communicate via a wireless communication with a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit, and
the computer is capable of controlling a display unit.

21. A program to make a computer for a console execute steps comprising;
a step to detect whether the console communication unit is under receiving radiograph data from the cassette or not;
a step to control the display unit to display an indication informing that the radiograph data is under reception when the console communication unit has been receiving the radiograph data from the cassette;
a step to detect whether the wireless communication is disabled or not while causing the display unit to display an indication of being under receiving radiograph data; and
a step to control the display unit to interrupt an indication of being under receiving radiograph data when the wireless communication has been detected being in the disabled state while causing the display unit to display the indication of being under receiving radiograph data,
wherein the computer is capable of controlling a console communication unit to communicate via a wireless communication with a cassette comprising: a cassette communication unit to communicate with the console via the wireless communication; a radiograph acquiring unit to acquire radiograph data by radiography; and a cassette control unit to control the cassette communication unit to transmit the radiograph data acquired from the radiograph acquiring unit, and
the computer is capable of controlling a display unit.

22. The program of claim 21, configured to execute a step to control a display unit to display an indication of disabled state when the wireless communication has been detected being in disabled state.
